(19) United States
(12) Patent Application Publication
(10) Pub. No.: US 2013/0285875 A1
(43) Pub. Date: Oct. 31, 2013

(54) FREQUENCY-VARIABLE CIRCUIT AND MULTI-BAND ANTENNA DEVICE

(71) Applicant: MURATA MANUFACTURING CO., LTD., KYOTO (JP)

(72) Inventor: Kazunari KAWAHATA, Kyoto (JP)

(21) Appl. No.: 13/928,139

(22) Filed: Jun. 26, 2013

Related U.S. Application Data
(63) Continuation of application No. PCT/JP2011/079138, filed on Dec. 16, 2011.

(30) Foreign Application Priority Data
Dec. 28, 2010 (JP) 2010-293028

(51) Int. Cl. H01Q 21/30

(52) U.S. Cl. CPC H01Q 21/30
USPC 343/852

(57) ABSTRACT

A multi-band antenna device includes a frequency variable circuit, a first radiating element used in a first frequency band, a second radiating element used in a second frequency band lower than the first frequency band, and a power supply circuit. The frequency variable circuit includes a parallel resonant circuit in which a capacitor and an inductor are connected in parallel, and a first variable capacitance element connected in parallel with the capacitor. An end of the parallel resonant circuit and the first variable capacitance element are connected to the power supply circuit and the first radiating element. Another end of the parallel resonant circuit and the first variable capacitance element are connected to the second radiating element. The parallel resonant circuit has a resonant frequency closer to the first frequency band than to the second frequency band.

### CROSS REFERENCE TO RELATED APPLICATIONS

The present application is a continuation of International Application No. PCT/JP2011/079138 filed on Dec. 16, 2011, and claims priority to Japanese Patent Application No. 2010-293028 filed on Dec. 28, 2010, the entire contents of each of these applications being incorporated herein by reference in their entirety.

### TECHNICAL FIELD

The technical field relates to a frequency variable circuit for use in a multi-band antenna that performs communication in a plurality of frequency bands, and a multi-band antenna device.

### BACKGROUND

In recent years, wireless communication apparatuses such as cellular phone terminals have been made into multi-band type that performs communication in a plurality of frequency bands. A multi-band wireless communication apparatus is equipped with an antenna device that supports a plurality of frequency bands. For example, International Publication No. 2006/080141 (Patent Document 1) describes an antenna device that supports a wide band and is able to simultaneously change a plurality of resonant frequencies only in a desired range. FIG. 1 is a diagram showing a configuration of the antenna device described in Patent Document 1. In the antenna device described in Patent Document 1, a frequency variable circuit 4 is interposed between a power supply electrode 5 and a radiating element 6 of the antenna, and the resonant frequency of the antenna is allowed to be changed by changing a reactance value of a variable capacitance diode provided in the frequency variable circuit 4.

In addition, Japanese Unexamined Patent Application Publication No. 2003-249811 (Patent Document 2) describes an antenna device that supports dual bands and in which a matching circuit is modified in order to provide matching at two resonant frequencies. FIG. 2 is a diagram showing a configuration of the antenna device described in Patent Document 2. The antenna device described in Patent Document 2 includes an antenna element 22 and a power supply circuit 23 that supplies power to the antenna element 22. An LC resonant circuit is connected between the antenna element 22 and the power supply circuit 23 and composed of inductance elements 25 and 26 and capacitance elements 28, 29, and 30. Specifically, the inductance element 25 and the capacitance element 28 are connected in series between the antenna element 22 and the power supply circuit 23. A high-pass type matching circuit is connected in parallel with a series resonant circuit composed of the inductance element 25 and the capacitance element 28 and is composed of the capacitance elements 29 and 30 and the inductance element 26. The LC resonant circuit is provided for resonating the antenna element 22 in two frequency bands and has a T-type circuit that is intended to prevent the impedance from becoming an infinite value in a certain frequency band and is composed of the inductance element 26 and the capacitance elements 29 and 30. Thus, it is possible to eliminate a point at which gain falls, namely, a notch, between the two resonant frequencies, and it is possible to prevent degradation of the gain. It should be noted that an inductance element 27 is provided for providing matching between the input impedance of the antenna element 22 and the impedance of the power supply circuit 23.

### SUMMARY

The present disclosure provides a frequency variable circuit and a multi-band antenna device that are allowed to perform communication in a plurality of frequency bands while reducing loss at a high frequency.

In one aspect of the present disclosure, a frequency variable circuit includes a parallel resonant circuit in which a capacitor and an inductor are connected in parallel, and a first variable capacitance element connected in parallel with the capacitor. An end of the parallel resonant circuit and a first electrode of the first variable capacitance element are connected to a power supply circuit and a first radiating element used in a first frequency band. Another end of the parallel resonant circuit and a second electrode of the first variable capacitance element are connected to a second radiating element used in a second frequency band lower than the first frequency band. The parallel resonant circuit has a resonant frequency closer to the first frequency band than to the second frequency band.

In another aspect of the present disclosure, a multi-band antenna device includes the above frequency variable circuit and performs communication in different frequency bands. The multi-band antenna device that includes the first radiating element connected to the frequency variable circuit, the second radiating element connected to the frequency variable circuit, and the power supply circuit connected to the frequency variable circuit.

In another more specific embodiment of a multi-band antenna device according to the present disclosure, the first radiating element may be connected at one end thereof to the power supply circuit and grounded at a portion thereof.

In yet another more specific embodiment of a multi-band antenna device according to the present disclosure, the first radiating element may be connected to the power supply circuit via a capacitance element.

In still another more specific embodiment of a multi-band antenna device according to the present disclosure, the capacitance element may be a second variable capacitance element.

In another more specific embodiment of a multi-band antenna device according to the present disclosure, the first and second variable capacitance elements may be MEMS elements. In another more specific embodiment of a multi-band antenna device according to the present disclosure, the first radiating element may have a length equivalent to a ½ wavelength of the first frequency band and may be connected at substantially a center portion thereof to the power supply circuit.

### BRIEF DESCRIPTION OF DRAWINGS

FIG. 1 is a diagram showing a configuration of an antenna device described in Patent Document 1.

FIG. 2 is a diagram showing a configuration of an antenna device described in Patent Document 2.

FIG. 3A is a diagram schematically showing a circuit configuration of a multi-band antenna device according to exemplary Embodiment 1.

FIG. 3B is a diagram schematically showing a circuit configuration of the multi-band antenna device according to exemplary Embodiment 1.

FIG. 4 is a diagram showing frequency characteristics of the return loss of the multi-band antenna device according to Embodiment 1.

FIG. 5 is a diagram showing frequency characteristics of the reactance of an LC parallel resonant circuit.

FIG. 6 is a diagram showing an equivalent circuit in FIG. 3A or FIG. 3B.

FIG. 7A is a diagram schematically showing a circuit configuration of a modified example of the multi-band antenna device according to exemplary Embodiment 1.

FIG. 7B is a diagram schematically showing a circuit configuration of a modified example of the multi-band antenna device according to exemplary Embodiment 1.

FIG. 8 is a diagram schematically showing a circuit configuration of a multi-band antenna device according to exemplary Embodiment 2.

FIG. 9 is a diagram schematically showing a circuit configuration of a multi-band antenna device according to exemplary Embodiment 3.

FIG. 10 is a diagram schematically showing a circuit configuration of a multi-band antenna device according to exemplary Embodiment 4.

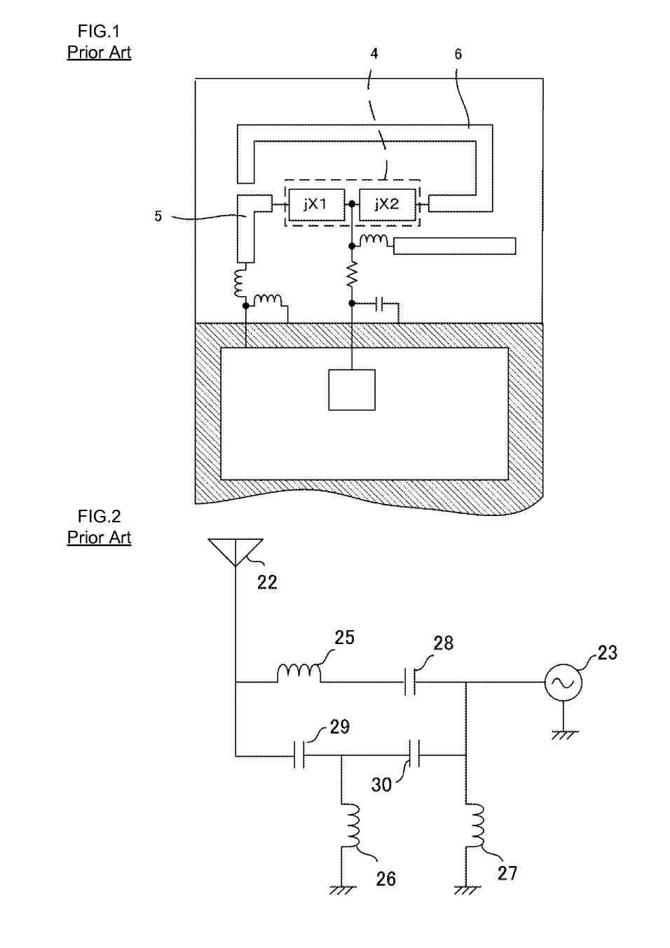

### DETAILED DESCRIPTION

The inventor realized that the antenna device described in Patent Document 1 has a problem that, when the frequency is increased, loss occurs due to a high-frequency resistance of the frequency variable circuit 4 and the antenna characteristics at a high frequency are deteriorated. For example, when the antenna device described in Patent Document 1 is used in a wireless communication apparatus, such as a cellular phone terminal, which performs communication in a frequency band of 800 MHz to 1.5 GHz, the above-described problem is significant. In addition, it is difficult for the antenna device described in Patent Document 1 to always simultaneously support a plurality of frequency bands.

Furthermore, the antenna device described in Patent Document 2 has an advantage that at a specific frequency, it is easy to provide impedance matching at the two resonant frequencies, but has a problem that when a variable reactance element is used in the matching circuit to make the frequency variable, loss is increased at a high frequency due to loss of the element and the antenna characteristics are deteriorated.

Hereinafter, preferred exemplary embodiments of a frequency variable circuit and a multi-band antenna device according to the present disclosure will be described with reference to the drawings. A multi-band antenna device described below may be one that performs communication using any of the GSM (Global System for Mobile Communications) system, the W-CDMA (Wideband Code Division Multiple Access) system, or another system, or may be one that performs communication using a combination of various systems such as LTE (Long Term Evolution).

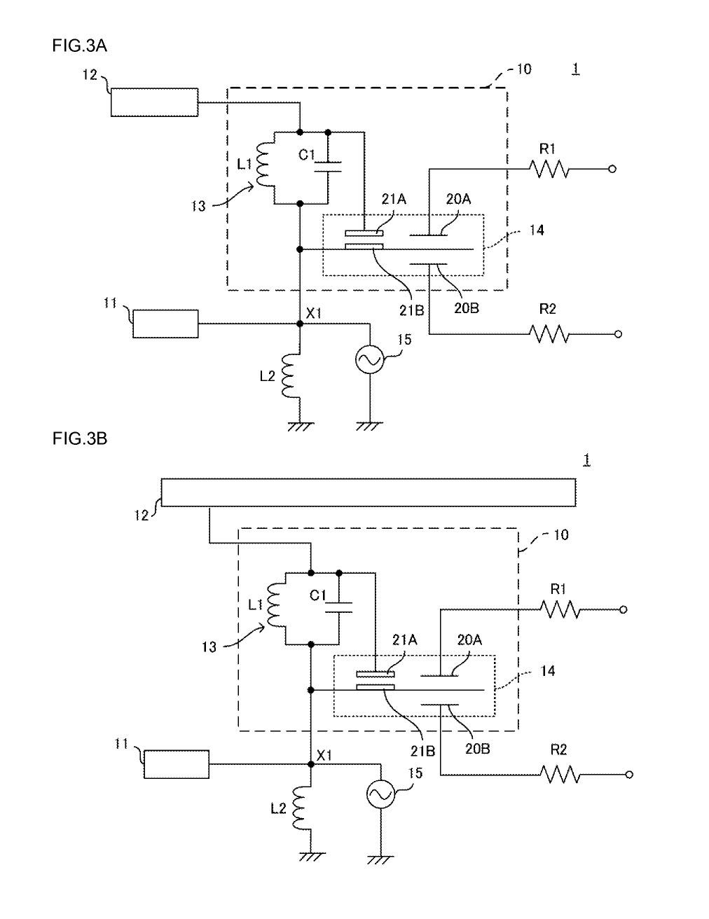

FIGS. 3A and 3B are diagrams each schematically showing a circuit configuration of a multi-band antenna device 1 according to exemplary Embodiment 1 of the present disclosure. The multi-band antenna device 1 according to the embodiment is able to perform communication in a first frequency band and a second frequency band located on the low frequency side of the first frequency band. The first frequency band is a high-frequency band (hereinafter, referred to as high band), and the second frequency band is a low-frequency band (hereinafter, referred to as low band). The multi-band antenna device 1 includes a first radiating element 11 and a second radiating element 12 supporting communication in the high band and the low band, an RF-MEMS (Radio Frequency-Micro Electro Mechanical Systems) circuit part 10, and a power supply circuit 15.

The first radiating element 11 and the second radiating element 12 are, for example, electrodes formed on a printed circuit board or a dielectric board. The first radiating element 11 has such a length as to operate mainly at a frequency f_{H} in the high band (1.7 GHz band in the embodiment). The second radiating element 12 has such a length as to operate mainly at a frequency f_{L}, in the low band (800 MHz band in the embodiment). It should be noted that the length of the second radiating element 12 is different between FIGS. 3A and 3B. Thus, the second radiating element 12 of the multi-band antenna device 1 shown in FIG. 3B operates at a lower frequency.

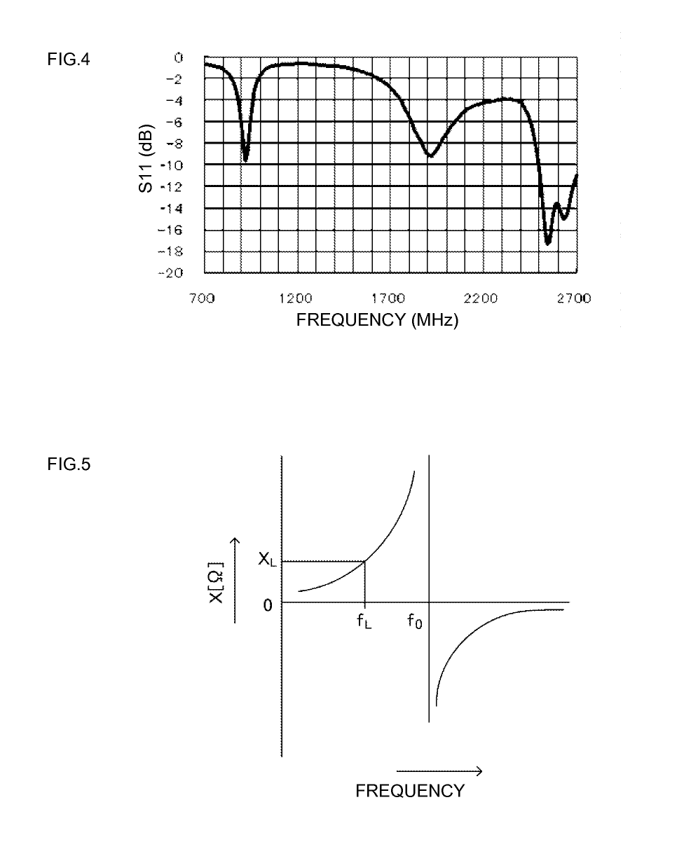

FIG. 4 is a diagram showing frequency characteristics of the return loss of the multi-band antenna device 1 according to the embodiment. In FIG. 4, the horizontal axis indicates a frequency (MHz), and the vertical axis indicates the magnitude (dB) of the return loss.

Since the multi-band antenna device 1 includes the first radiating element 11 and the second radiating element 12, a resonant state (valley of the return loss characteristics) occurs in two frequency bands, namely, the high band centered at 1.7 GHz and the low band centered at 800 MHz, as shown in FIG. 4.

The first radiating element 11 is opened at one end thereof and is connected at another end thereof to the power supply circuit 15 directly or via a capacitance. The second radiating element 12 is opened at one end thereof and is connected at another end thereof to the power supply circuit 15 via the RF-MEMS circuit part 10 as a variable capacitance circuit. The RF-MEMS circuit part 10 will be described in detail later.

An inductor L2 for matching is connected between the RF-MEMS circuit part 10 and the power supply circuit 15 and between the first radiating element 11 and the power supply circuit 15 and is grounded at one end thereof. The inductor L2 is a matching element mainly for the first radiating element 11 and the second radiating element 12. Hereinafter, a connection point between the RF-MEMS circuit part 10 and the power supply circuit 15 and between the first radiating element 11 and the power supply circuit 15 between which the inductor L2 is connected is referred to as power supply point X1.

Thus, the first radiating element 11 is opened at one end thereof and is connected at another end thereof to the power supply circuit 15 and the inductor L2 via the power supply point X1. In addition, the second radiating element 12 is opened at one end thereof and is connected at another end thereof to the power supply circuit 15 and the inductor L2 via the RF-MEMS circuit part 10 and the power supply point X1.

The power supply circuit 15 is connected to a transmitting/receiving circuit (RF circuit) with which the multi-band antenna device 1 performs communication in the low band and the high band via the first radiating element 11 and the second radiating element 12.

The RF-MEMS circuit part 10 includes an MEMS element 14 and a tank circuit 13.

The tank circuit 13 is formed so as to have high impedance in the first frequency band (high band) and so as to be inductive in the second frequency band (low band) and is an LC parallel resonant circuit formed by an inductor L1 and a capacitor C1 being connected in parallel.

In the tank circuit 13, constants of the inductor L1 and the capacitor C1 are set such that its parallel resonant frequency falls within the high band. In addition, when the tank circuit 13 is coupled to the first radiating element 11 and designed such that the harmonic of the second radiating element 12 is excited, it is possible to provide matching also at a frequency (about 2.3 to 2.5 GHz) near the frequency of the third harmonic of the low band (800 MHz).

FIG. 5 is a diagram showing frequency characteristics of the reactance of the LC parallel resonant circuit. In FIG. 5, the horizontal axis indicates the frequency of a voltage supplied to the LC parallel resonant circuit, and the vertical axis indicates the reactance X of the LC parallel resonant circuit. As shown in FIG. 5, the LC parallel resonant circuit has maximum impedance at the resonant frequency f_{O} of the LC parallel resonant circuit and is inductive in a frequency range lower than the resonant frequency f_{O}.

Therefore, when the resonant frequency is set at the frequency f_{H}, the tank circuit 13 is able to block a signal of the frequency f_{H} used in communication in the high band, from flowing to the second radiating element 12. Thus, it is possible to suppress coupling between the first radiating element 11 and the second radiating element 12. Furthermore, in the multi-band antenna device 1, when communication is performed in the high band, a signal of the frequency f_{H} does not flow to the tank circuit 13, and thus high-frequency loss by the tank circuit 13 is reduced.

In addition, in the tank circuit 13, the resonant frequency is set at the frequency f_{H} as described above, and a constant (a reactance X_{L} in the case of FIG. 5) is set such that a signal of the frequency f_{L}, used in communication in the low band is allowed to pass therethrough. The tank circuit 13 is inductive at the frequency f_{L}, lower than the resonant frequency f_{O} set at the frequency f_{H}. Thus, in the multi-band antenna device 1, when communication is performed in the low band, a signal of the frequency f_{L}, is not blocked by the tank circuit 13, whereby communication in the low band is enabled.

Furthermore, since a signal of the frequency f_{L} passes through the inductive tank circuit 13, wavelength shortening by the inductance is performed. As a result, since the wavelength is shortened by the wavelength shortening effect, it is possible to reduce the size of the multi-band antenna device 1.

As described above, by the action of the tank circuit 13, the multi-band antenna device 1 according to the embodiment obtains two resonant states in the low band and the high band as described with reference to FIGS. 3A and 3B, and is enabled to perform communication in the low band and the high band without switching a communication frequency band.

In addition, since the tank circuit 13 blocks a signal of the frequency f_{H} from passing therethrough, the multi-band antenna device 1 according to the embodiment is able reduce high-frequency loss in communication in the high band, resulting in that it is possible to suppress deterioration of the antenna characteristics.

In the RF-MEMS circuit part 10, the MEMS element 14 is connected to the tank circuit 13. The MEMS element 14 is a first variable capacitance element and is able to change an RF capacitance value to a desired value in accordance with the level of an applied bias voltage (drive voltage). In FIGS. 3A and 3B, the MEMS element 14 is shown in a simplified manner, but the MEMS element 14 includes driving electrodes 20A and 20B, capacitance electrodes 21A and 21B, and the like.

The capacitance electrodes 21A and 21B face each other, the capacitance electrode 21A is connected to one end (first end) of the tank circuit 13, and the capacitance electrode 21B is connected to another end (second end) of the tank circuit 13. The capacitance electrode 21A is formed at a fixed part, and the capacitance electrode 21B is formed at a movable part made of metal or the like. The driving electrodes 20A and 20B drive the movable part with an electrostatic force.

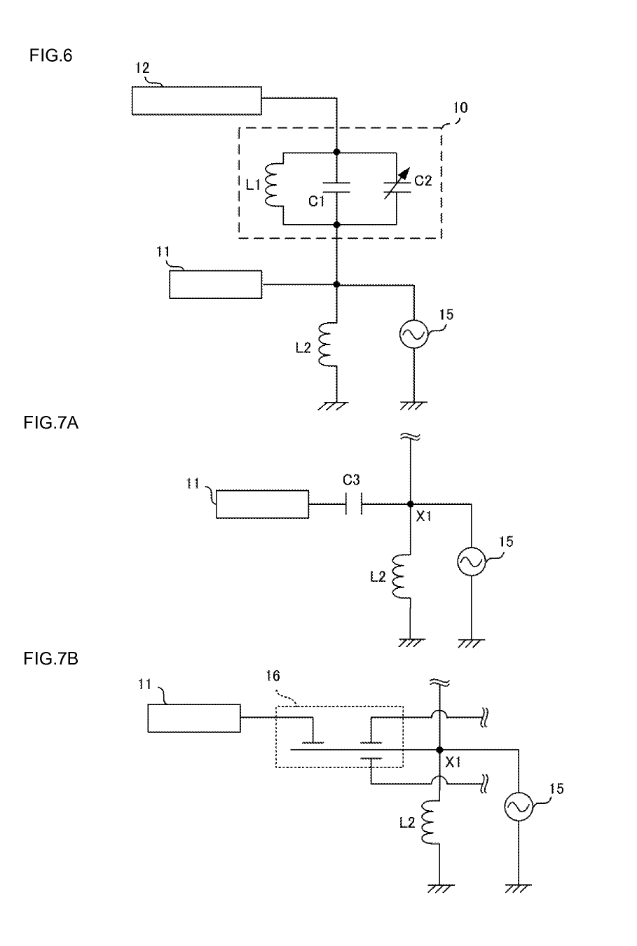

FIG. 6 is a diagram showing an equivalent circuit of FIG. 3A or 3B. As described above, the capacitance electrodes 21A and 21B constitute a variable capacitance C2 that is an RF capacitance, and are connected to the tank circuit 13. As shown in FIG. 6, the RF-MEMS circuit part 10 is an LC parallel resonant circuit formed by the inductor L1, the capacitor C1, and the variable capacitance C2 being connected in parallel.

The driving electrode 20A is connected to a control part (not shown) via a resistor R1. In addition, the driving electrode 20B is connected to the control part via a resistor R2. A bias voltage (drive voltage) for generating an electrostatic force is applied from the control part to each of the driving electrode 20A and the driving electrode 20B.

In the MEMS element 14, when the bias voltage is applied to the driving electrodes 20A and 20B, the movable part is moved by an electrostatic force. Thus, the distance between the capacitance electrode 21A and the capacitance electrode 21B is changed, and the capacitance value of the variable capacitance C2 formed by the capacitance electrode 21A and the capacitance electrode 21B is changed. For example, the bias voltage is applied to the driving electrode 20A, the movable part approaches the driving electrode 20A by an electrostatic force, and thus the capacitance electrode 21A and the capacitance electrode 21B approach each other. As a result, the capacitance value of the variable capacitance C2 is increased.

Meanwhile, when the bias voltage is applied to the driving electrode 20B, the movable part approaches the driving electrode 20B by an electrostatic force, and thus the capacitance electrode 21A and the capacitance electrode 21B are moved away from each other. As a result, the capacitance value of the variable capacitance C2 is decreased.

In the RF-MEMS circuit part 10, by changing the capacitance value of the variable capacitance C2 with the MEMS element 14, it is possible to shift the center frequency of the low band (the valley of the return loss characteristics shown in FIG. 4) from the frequency f_{L}, (800 MHz) to the high frequency side or the low frequency side. In other words, the RF-MEMS circuit part 10 is a frequency variable circuit.

More specifically, the constants of the inductor L1 and the capacitor C1 of the tank circuit 13 are set such that the parallel resonant frequency of the tank circuit 13 falls within the high band (e.g., 1.71 to 1.88 GHz) and the tank circuit 13 is inductive in the low band. In this case, by changing the capacitance value of the variable capacitance C2 connected in parallel with the capacitor C1, it is possible to change the reactance of the tank circuit 13 and change the resonant frequency of the second radiating element 12 to a predetermined frequency.

It should be noted that in FIGS. 3A and 3B, the first radiating element 11 and the power supply circuit 15 are directly connected to each other, but isolation characteristics between the first and second radiating elements 11 and 12, which perform communication in the low band and the high band, may be further enhanced by interposing a capacitance element between the first radiating element 11 and the power supply circuit 15.

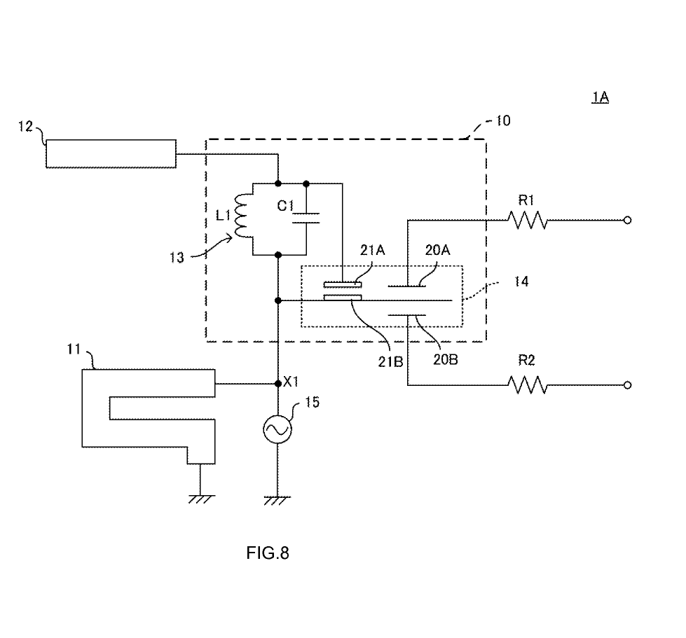

FIGS. 7A and 7B are diagrams each schematically showing a circuit configuration of a modified example of the multi-band antenna device according to Embodiment 1 of the present disclosure. In the modified examples shown in FIGS. 7A and 7B, a capacitance element is connected between the first radiating element 11 and the power supply circuit 15. In FIGS. 7A and 7B, only a part of a circuit of a multi-band antenna device that is the modified example is shown.

In the modified example shown in FIG. 7A, a capacitor C3 is connected between the first radiating element 11 and the power supply circuit 15. In the modified example shown in FIG. 7B, an MEMS element 16 that is a variable capacitance element is connected between the first radiating element 11 and the power supply circuit 15. It should be noted that the MEMS element 16 in the modified example shown in FIG. 7B has the same configuration as that of the MEMS element 14, but is controlled independently of the MEMS element 14.

As shown in FIG. 7B, the same advantageous effects as those in FIG. 7A are obtained by connecting the MEMS element 16. In addition, by connecting the MEMS element 16 and changing its capacitance value, it is possible to independently change the frequency f_{H} (the resonant frequency of the first radiating element 11) used in communication in the high band.

As described above, the multi-band antenna device 1 according to the embodiment reduces high-frequency loss by the tank circuit 13 and is enabled to perform communication in the low band and the high band. In addition, by changing the capacitance value of the variable capacitance C2 with the MEMS element 14, it is possible to change the reactance of the tank circuit 13 and change the resonant frequency of the second radiating element 12 to a predetermined frequency.

Hereinafter, exemplary Embodiment 2 of the present disclosure will be described. It should be noted that the same components as those in Embodiment 1 are designated by the same reference signs and the description thereof is omitted.

FIG. 8 is a diagram schematically showing a circuit configuration of a multi-band antenna device 1A according to Embodiment 2 of the present disclosure. The multi-band antenna device 1A according to the embodiment is different from the multi-band antenna device 1 according to Embodiment 1 in that the inductor L2, which is a matching element, is not included and the first radiating element 11 is not opened but grounded at one end thereof.

In the multi-band antenna device 1A according to the embodiment, the first radiating element 11 supporting communication in the high band is connected at one end thereof to the power supply circuit 15 via the power supply point X1 and grounded at another end thereof. Thus, in the case of communication in the low band, the first radiating element 11 is grounded so as to be inductive, and it is possible to use the first radiating element 11 as a matching element in the second frequency band. As a result, it is possible to make the inductor L2 in Embodiment 1 unnecessary.

It should be noted that in the embodiment, an end portion of the first radiating element 11 is grounded, but a portion of the first radiating element 11 other than the end portion may be grounded, and it is possible to appropriately change the grounded portion in accordance with the antenna characteristics or the like of the multi-band antenna device.

As described above, the multi-band antenna device 1A according to the embodiment provides the same advantageous effects as those in Embodiment 1, and it is also possible to cause the first radiating element 11 to serve as a matching element. Thus, it is possible to reduce the number of components.

Hereinafter, exemplary Embodiment 3 of the present disclosure will be described. It should be noted that the same components as those in Embodiment 1 are designated by the same reference signs and the description thereof is omitted.

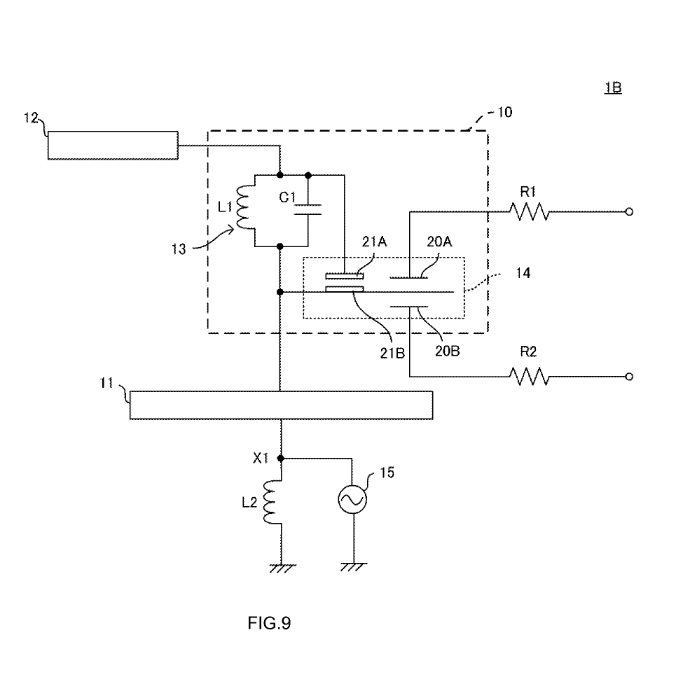

FIG. 9 is a diagram schematically showing a circuit configuration of a multi-band antenna device 1B according to Embodiment 3 of the present disclosure. The multi-band antenna device 1B according to the embodiment is different from the multi-band antenna device 1 according to Embodiment 1 in that power is supplied to the center of the first radiating element 11.

The first radiating element 11 supporting communication in the high band is opened at both ends thereof. In the case where the radiating element is opened at both ends thereof as described above, a high-frequency current that occurs on the radiating element in a resonant state of the antenna is at its maximum at the center of the radiating element and is at its minimum at both ends of the radiating element.

Thus, in the embodiment, the first radiating element 11 has a length equivalent to the ½ wavelength of the first frequency band, the RF-MEMS circuit part 10 including the tank circuit 13 is connected to one side of a center portion of the first radiating element 11 which is a portion of the first radiating element 11 where the high-frequency current is at its maximum, and the power supply circuit 15 is connected to the other side of the center portion. Thus, it is possible to reduce the influence caused by the tank circuit 13 being connected to the high-impedance first radiating element 11. Thus, even when the resonant frequency of the second radiating element 12 is changed to a predetermined frequency, it is possible to further reduce the influence on the resonant frequency of the first radiating element 11.

As described above, the multi-band antenna device 1B according to the embodiment provides the same advantageous effects as those in Embodiment 1, and it is also possible to reduce the influence of the second radiating element 12 on the resonant frequency of the first radiating element 11.

It should be noted that it is possible to appropriately change the designs of the specific configuration and the like of the multi-band antenna device, the advantageous effects described in the aforementioned embodiments are merely the most preferred advantageous effects provided from the present disclosure, and the advantageous effects provided by the present disclosure are not limited to those described in the aforementioned embodiments.

For example, in the aforementioned embodiments, the control part which drives the MEMS element 14 is provided outside the RF-MEMS circuit part 10, but a control part including a boost DC-DC convertor and the like for driving the MEMS element 14 may be included in the RF-MEMS circuit part 10. In this case, it is possible to further shorten a wire connected to the RF-MEMS circuit part 10, and thus it is possible to reduce the influence of noise caused by routing the wire.

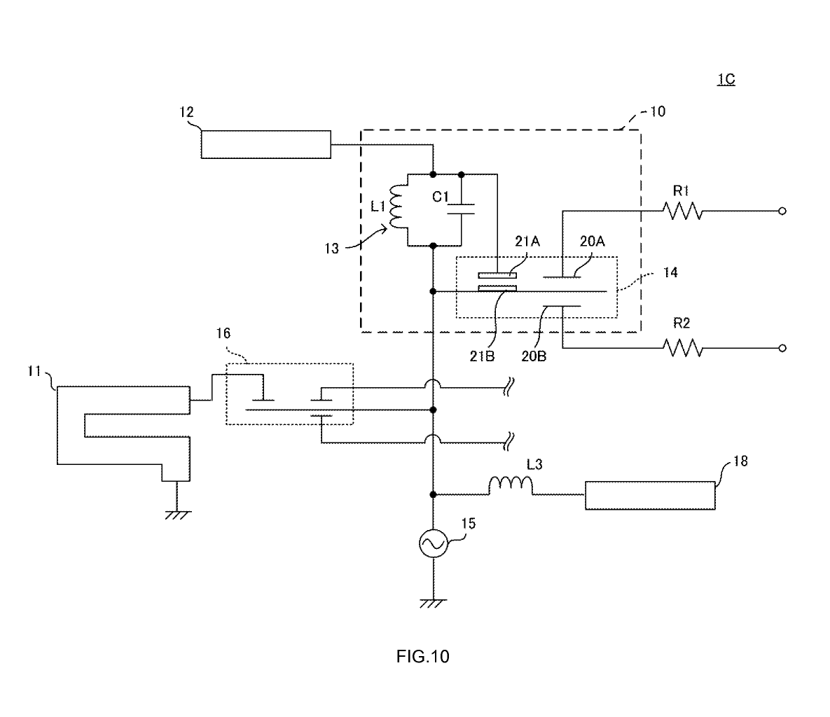

Hereinafter, exemplary Embodiment 4 of the present disclosure will be described. It should be noted that the same components as those in Embodiment 1 are designated by the same reference signs and the description thereof is omitted. FIG. 10 is a diagram schematically showing a circuit configuration of a multi-band antenna device 1C according to Embodiment 4 of the present disclosure. The multi-band antenna device 1C according to the embodiment is different from the multi-band antenna device 1 according to Embodiment 1 in that: a third radiating element 18 having such a length as to operate in a frequency band different from those of the first radiating element 11 and the second radiating element 12 is connected to the power supply circuit 15 via an inductor L3; the MEMS element 16, which is a variable capacitance element, is connected between the first radiating element 11 and the power supply circuit 15; the inductor L2, which is a matching element, is not included; and the first radiating element 11 is not opened but grounded at one end thereof.

In this case, the multi-band antenna device 1C shown in FIG. 10 is enabled to perform communication in another frequency band in addition to the aforementioned high band and low band. In addition, by providing the MEMS element 16 and changing its capacitance value, it is possible to independently change the frequency f_{H} (the resonant frequency of the first radiating element 11) used in communication in the high band, and it is possible to further enhance isolation characteristics between the first radiating element 11 and the second radiating element 12.

With this configuration, since the first radiating element used in the first frequency band and the second radiating element used in the second frequency band lower than the first frequency band are included, it is possible to simultaneously perform communication at frequencies in a high frequency band and a low frequency band.

In embodiments according to the present disclosure, the first radiating element supporting a high frequency is connected to the second radiating element via the parallel resonant circuit which resonates in the first frequency band. Thus, the parallel resonant circuit seen from the first radiating element side has high impedance and acts as if being connected in a state where the parallel resonant circuit side is nearly equivalently opened. Therefore, the radiating element for the first frequency band is hard to couple to the radiating element for the second frequency band. Furthermore, in the radiating element for the first frequency band, a high-frequency signal is hard to flow to the frequency variable circuit including the parallel resonant circuit, and thus it is possible to reduce loss in the first frequency band by the frequency variable circuit including the parallel resonant circuit. Moreover, the frequency variable circuit including the parallel resonant circuit is inductive in the second frequency band, and thus it is possible to lower the frequency even when the second radiating element is not made into a complicated shape.

Furthermore, since the first variable capacitance element is used as a capacitor of the parallel resonant circuit, it is possible to change the value of the reactance between the second radiating element and the power supply circuit by changing the capacitance value of the first variable capacitance element. Thus, it is possible to realize a tunable antenna device or shiftable antenna device that is able to change its communication frequency in the second frequency band, for example, 800 MHz to 900 MHz.

In embodiments of a multi-band antenna device according to the present disclosure in which the first radiating element is connected at one end thereof to the power supply circuit and grounded at a portion thereof, in the case of communication in the second frequency band, the first radiating element is grounded so as to be inductive, and it is possible to use the first radiating element as a matching element in the second frequency band. Thus, it is unnecessary to use a matching element and it is possible to reduce the number of components.

In embodiments of a multi-band antenna device according to the present disclosure in which the first radiating element is connected to the power supply circuit via a capacitance element, since the first radiating element is connected to the power supply circuit via the capacitance element, it is possible to prevent a signal of the second frequency band lower than the first frequency band from flowing to the first radiating element. As a result, it is possible to further enhance isolation characteristics between the first and second radiating elements which perform communication in the low frequency band and the high frequency band.

In embodiments of a multi-band antenna device according to the present disclosure in which the capacitance element is a second variable capacitance element, it is possible to independently control the resonant frequency of the first radiating element and the resonant frequency of the second radiating element. In addition, it is also possible to adjust impedance matching with respect to the second radiating element while changing the frequency.

In embodiments of a multi-band antenna device according to the present disclosure in which the first and second variable capacitance elements are MEMS elements, by using the MEMS elements, it is possible to reduce distortion or loss of a signal.

In embodiments of a multi-band antenna device according to the present disclosure in which the first radiating element has a length equivalent to a ½ wavelength of the first frequency band and is connected at substantially a center portion thereof to the power supply circuit, it is possible to further reduce the influence caused by the high-impedance parallel resonant circuit being connected to the first radiating element. Thus, even when the resonant frequency of the second radiating element is changed to a predetermined frequency, it is possible to further reduce the influence on the resonant frequency of the first radiating element.

According to the multi-band antenna device according to the present disclosure, high-frequency loss by the parallel resonant circuit is reduced and communication in the first frequency band and the second frequency band is enabled. In addition, by changing the capacitance value with the first variable capacitance element, it is possible to change the reactance of the parallel resonant circuit and change the resonant frequency of the second radiating element to a predetermined frequency.

That which is claimed is:

1. A frequency variable circuit comprising:
a parallel resonant circuit in which a capacitor and an inductor are connected in parallel; and
a first variable capacitance element connected in parallel with the capacitor, wherein
an end of the parallel resonant circuit and a first electrode of the first variable capacitance element are connected to a power supply circuit and a first radiating element used in a first frequency band,
another end of the parallel resonant circuit and a second electrode of the first variable capacitance element are connected to a second radiating element used in a second frequency band lower than the first frequency band, and
the parallel resonant circuit has a resonant frequency closer to the first frequency band than to the second frequency band.

2. A multi-band antenna device including the frequency variable circuit according to claim 1 and performing communication in different frequency bands, the multi-band antenna device comprising:
the first radiating element connected to the frequency variable circuit;
the second radiating element connected to the frequency variable circuit; and
the power supply circuit connected to the frequency variable circuit.

3. The multi-band antenna device according to claim 2, wherein the first radiating element is connected at one end thereof to the power supply circuit and grounded at a portion thereof.

4. The multi-band antenna device according to claim 2, wherein the first radiating element is connected to the power supply circuit via a capacitance element.

5. The multi-band antenna device according to claim 4, wherein the capacitance element is a second variable capacitance element.

6. The multi-band antenna device according to claim 5, wherein the second variable capacitance element is an MEMS element.

7. The multi-band antenna device according to claim 2, wherein the first radiating element has a length equivalent to a ½ wavelength of the first frequency band and is connected at substantially a center portion thereof to the power supply circuit.

8. The multi-band antenna device according to claim 2, wherein the first variable capacitance element is an MEMS element.

9. The multi-band antenna device according to claim 3, wherein the first variable capacitance element is an MEMS element.

10. The multi-band antenna device according to claim 4, wherein the first variable capacitance element is an MEMS element.

11. The multi-band antenna device according to claim 5, wherein the first variable capacitance element is an MEMS element.

12. The multi-band antenna device according to claim 6, wherein the first variable capacitance element is an MEMS element.

13. The multi-band antenna device according to claim 7, wherein the first variable capacitance element is an MEMS element.
